(19) United States
(12) Patent Application Publication
(10) Pub. No.: US 2012/0177871 A1
(43) Pub. Date: Jul. 12, 2012

(54) IMPACT RESISTANT FOAMED GLASS MATERIALS FOR VEHICLES AND STRUCTURES

(76) Inventor: W. Gene Ramsey, Las Cruces, NM (US)

(21) Appl. No.: 12/121,257

(22) Filed: May 15, 2008

Related U.S. Application Data
(62) Division of application No. 11/530,506, filed on Sep. 11, 2006, now abandoned.

(51) Int. Cl. F41H 5/04; B32B 17/10; B32B 5/26; B32B 17/12

(52) U.S. Cl. 428/113; 428/312.6; 442/1

(57) ABSTRACT

An impact resistant layered armor system including a base layer of foamed glass material and an outer layer of relatively tough projectile retentive material. The foamed glass material is substantially isotropic, with a bulk density of between about 0.1 and 0.35 grams per cubic centimeter. The foamed glass material is characterized by a plurality of randomly oriented substantially identically sized cells and is substantially amorphous.

### CROSS-REFERENCE TO RELATED APPLICATIONS

This application is a Divisional of co-pending U.S. patent application Ser. No. 11/530,506, filed Sep. 11, 2006.

### TECHNICAL FIELD

The novel technology relates generally to the field of ceramic materials and, specifically, to an impact resistant material having a foamed vitreous base layer portion.

### BACKGROUND

Armor is used by the military and law enforcement agencies to protect men, vehicles and equipment from harm from projectiles and explosions. As increasingly sophisticated weapons technology has produced deadlier explosives and projectiles, the demands on protective armor have likewise become increasingly stringent. One such demand is that the armor be able to stop faster projectiles with greater penetrating power. Another such demand is that the armor be lighter in weight.

A variety of lightweight armor systems have been developed for use in a wide range of applications, including, aircraft, ground vehicles, and personal body armor applications. These armor systems have advanced well beyond the single layer of a hard (and typically brittle) material, such as hardened steel or ceramics, to include layers of energy absorbing material, such as KEVLAR fibers (KEVLAR is a registered trademark of E. I. Du Pont de Nemours and Company, 1007 Market Street, Wilmington, Del. 19898). The energy absorbing layers tend to reduce the spallation caused by impact of the projectile with the hardened material or “impact layer” of the armor to thus reduce the damage caused by the projectile impact, thus protecting against more powerful projectiles and increasing the effective life of the armor (and protected men and equipment).

While such layered armor systems are improvements over older monolayered armor, they still present certain drawbacks. The layered armor systems currently in use tend to include one or more metal or densified ceramic layers, which add significant weight to the armor. Often, powdered or liquid metal is infiltrated into void space in the ceramic and/or fibrous portions of the armor to create a resistant, but heavy, composite material. While useful, such armor systems tend to be relatively difficult to produce, expensive, and heavy. Thus, there remains a need for an easily produced, lightweight, and/or more economical armor material that is still resistant to penetration by high velocity projectiles and high explosives. The novel technology discussed herein addresses this need.

### SUMMARY

The novel technology discussed herein relates to a layered armor material having a foamed glass energy absorbing layer and a tough impact layer, and the method for making the same. One object of the present novel technology is to provide improved armor for vehicles and buildings material. Related objects and advantages of the present novel technology will be apparent from the following description.

### BRIEF DESCRIPTION OF THE DRAWINGS

FIG. 1A is a perspective sectional view of a first embodiment layered armor system of the novel technology.

FIG. 1B is an enlarged view of the interface between a foamed glass layer and an armor retentive impact layer of FIG. 1A.

FIG. 1C is an enlarged view of the foamed glass layer of FIGS. 1A and 1B.

FIG. 2A is a perspective sectional view of a second embodiment multiple-layered armor system of the present novel technology

FIG. 2B is an enlarged view of the interfaces between several foamed glass and armor retentive impact layers of FIG. 2A.

FIG. 3A is an exploded view of stacked laminated and non-laminated impact layers of a third embodiment layered armor system of the novel technology.

FIG. 3B is a perspective sectional view of a third embodiment layered armor system of the novel technology.

FIG. 3C is an enlarged view of the interface between a foamed glass layer and an armor retentive impact layer of FIG. 3B.

FIG. 4A is an exploded view of stacked laminated and non-laminated impact layers of a fourth embodiment layered armor system of the novel technology.

FIG. 4B is a perspective sectional view of a fourth embodiment layered armor system of the novel technology.

FIG. 4C is an enlarged view of the interface between a foamed glass layer and an armor retentive impact layer of FIG. 4B.

### DETAILED DESCRIPTION OF THE PREFERRED EMBODIMENTS

For the purposes of promoting an understanding of the principles of the novel technology and presenting its currently understood best mode of operation, reference will now be made to the embodiments illustrated in the drawings and specific language will be used to describe the same. It will nevertheless be understood that no limitation of the scope of the novel technology is thereby intended, with such alterations and further modifications in the illustrated device and such further applications of the principles of the novel technology as illustrated therein being contemplated as would normally occur to one skilled in the art to which the novel technology relates.

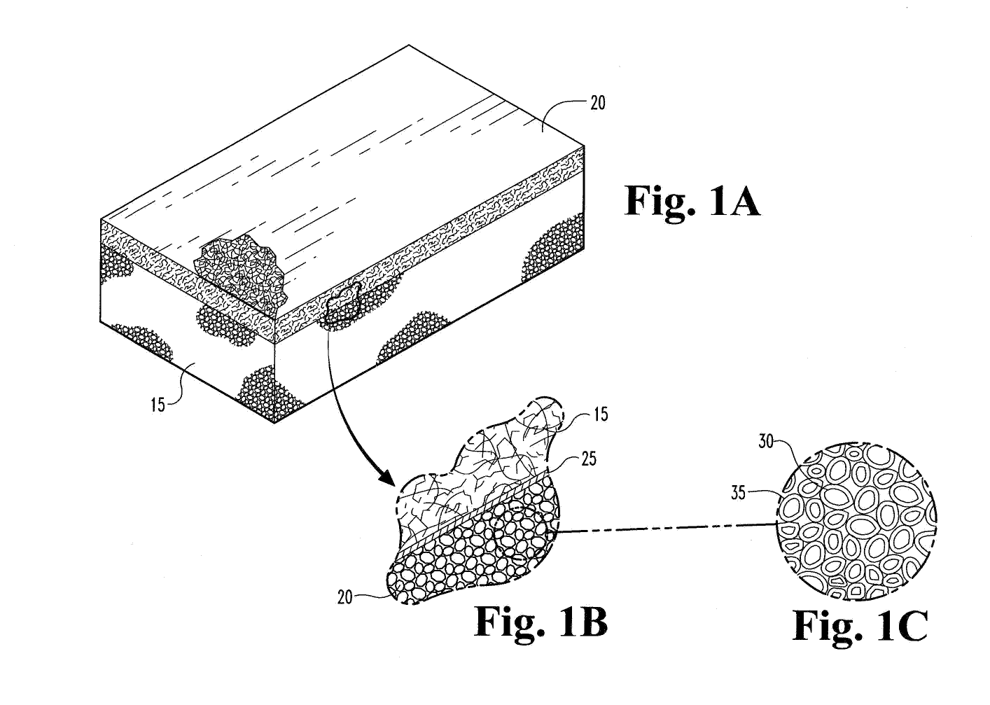

FIGS. 1A-1C illustrate a first embodiment of the present novel technology, a substantially rigid laminate or layered armor system 10 having a first or base layer 15 of a foamed vitreous material and a second outer or impact layer 20 of a relatively tough projectile retentive material. Typically, the foamed vitreous layer 15 is bonded or adhered to the impact layer 20, such as by an intermediate bonding layer 25. The bonding layer 25 may be cementitious, polymer-based, or the like.

The vitreous layer 15 is typically a foamed glass material characterized by a substantially isotropic cell structure. The cells 30 are typically of substantially uniform size, and are more typically of a size ranging from between about 0.1 to 1 millimeter in diameter. The cells 30 are typically characterized by cell walls 35 characterized by thicknesses from between about 5 percent to about 50 percent the cell diameter. The vitreous layer 15 is typically characterized by at least about 300 cells per cubic centimeter, although the cell density may be substantially more or less than 300 cells per cubic centimeter. The bulk density of the vitreous layer is typically between about 0.1 and 0.35 grams per cubic centimeter, although in some embodiments the density of the vitreous layer may be substantially outside the 0.1 to 0.35 grams per cubic centimeter range. The vitreous layer 15 is typically substantially amorphous, having only trace amounts of crystalline character. More typically, the vitreous layer 15 is substantially completely amorphous. Also typically, the orientation of the cells is substantially completely random, i.e., the layer 15 is isotropic in character regarding its physical properties.

The impact layer 20 is typically formed of a tough material, such as a fibrous materials (e.g., KEVLAR), organic aramids, polymers, ceramic plates, ceramic composites, cer-mets, meshes, metal-fiberglass meshes, woven fabrics, wires, metals, foamed metals, or the like. Typically, the impact layer 20 is selected such that the system 10 has a characteristic overall density of less than 0.6 grams per cubic centimeter.

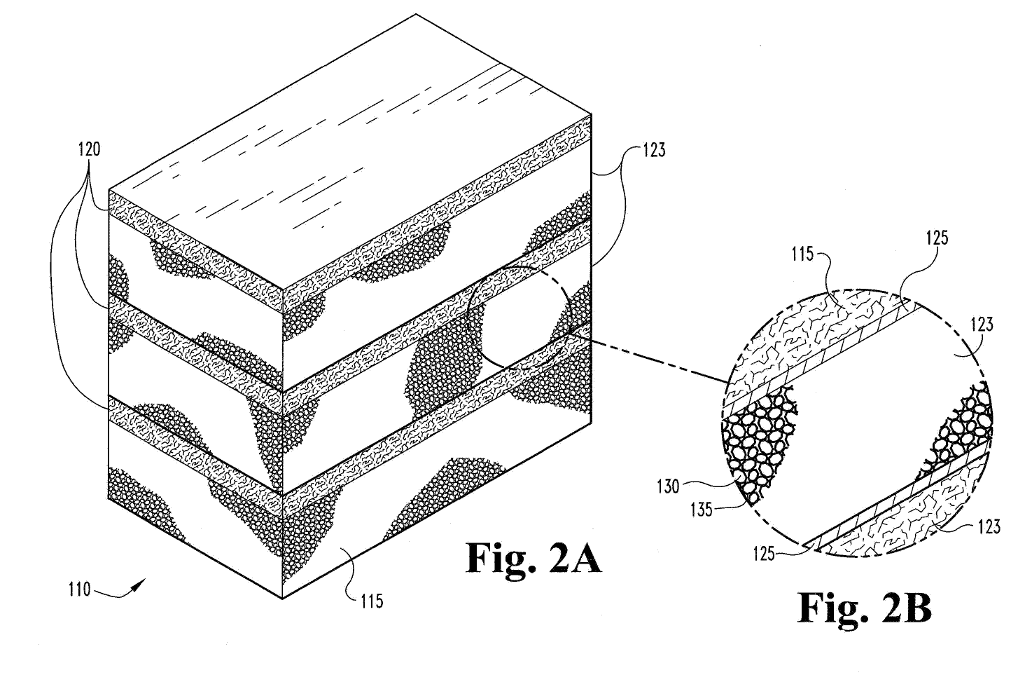

FIGS. 2A-2B illustrate a second embodiment of the present novel technology, a substantially rigid laminate or layered armor system 110 having a first or base layer 115 of a foamed vitreous material and a plurality of impact layers 120 of a relatively tough material alternating with foamed vitreous layers 123. As in the previous embodiment, the foamed vitreous layers 115, 123 are bonded or adhered to the adjacent impact layers 120, such as by intermediate bonding layers 125 of cementitious, polymer-based, or like material.

As above, the vitreous layers 115, 123 are typically an isotropic foamed glass material with a substantially uniformly sized cell structure 130. The cells 130 typically range from between about 0.1 to 1 millimeter across and have walls 135 about 5 percent to about 50 percent the thickness of the cell 130. The impact layers 120 are likewise typically formed of a tough material like the layer 20 described above. Different respective impact layers 120 may have different compositions. Typically, the composition(s) of the impact layers 120 are selected such that the system 110 has a characteristic overall density of less than 0.6 grams per cubic centimeter.

In operation, the system(s) 10/110 operate to resist projectile penetration by spreading the energy of the projectile over a volume of armor 10/110, wherein the energy is directed to crushing hundreds of cells 30/130. A projectile impacting an outer impact layer 20/120 transfers most or all of its energy into the system 10/110 where it is expended breaking cell walls 35/135 in the base layer 15/115 and or intervening layers 123. The foamed vitreous layer(s) 15/115/123 thus mitigate transmission of the impact force of a projectile by redirecting the energy of the projectile for use in crushing pluralities of cells 30/130. In other words, the foamed vitreous material 15/115/123 acts to redirect the impact energy off the plane of attack, thus allowing the system 10/110 to both retard ballistic penetration and mitigate transmission of impact force. The cellular structure of the vitreous layer(s) 15/115/123 acts to broaden the compressive stress from a ballistic impact across a cross section of the rigid material 10/110 to redirect and absorb force though individual cell failure.

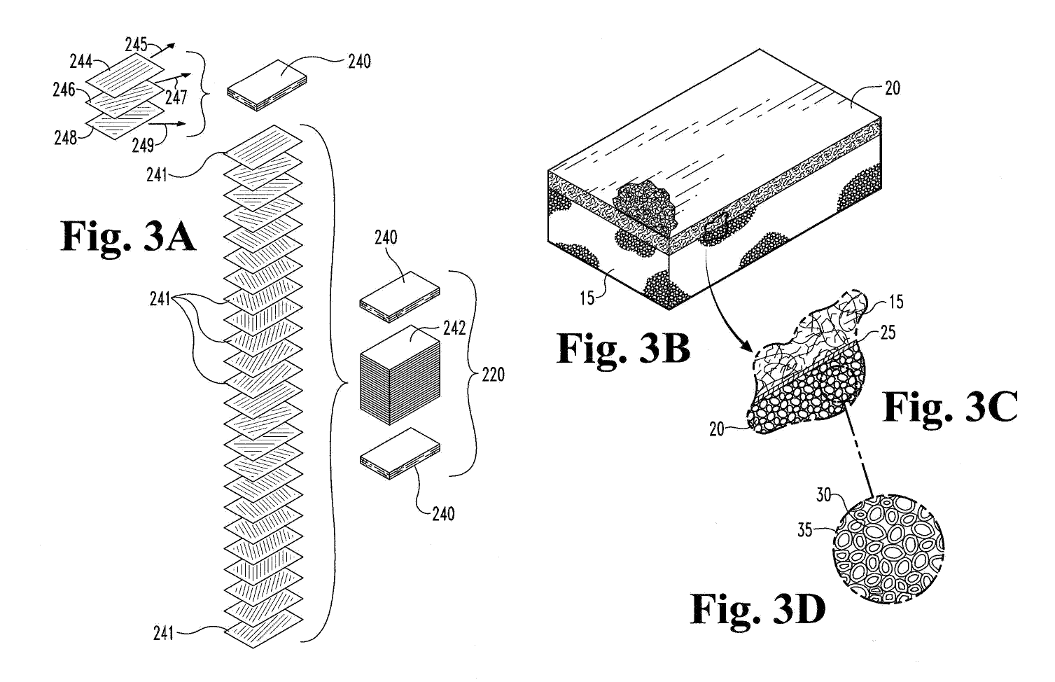

FIGS. 3A-3C illustrate a third embodiment of the novel technology, a substantially rigid laminate or layered armor system 210 similar to that illustrated as FIGS. 1A-1C and described above, having an foamed vitreous base layer 215 adjacent an impact layer 220, but wherein the impact layer 220 further includes top and bottom laminated portions 240 with a multilayered pouch portion 242 positioned therebetween. Typically, the foamed vitreous layer 215 is fastened or adhered to the impact layer 220, such as by mechanical fasteners or a light intermediate bonding layer 225. The bonding layer 225 may be cementitious, polymer-based, or the like.

As with the previous embodiments, the vitreous layer 215 is typically a foamed glass material characterized by a substantially isotropic cell structure. The cells 230 are typically of substantially uniform size, and are more typically of a size ranging from between about 0.1 to 1 millimeter I diameter. The cells 230 are typically characterized by cell walls 235 characterized by thicknesses from between about 5 percent to about 50 percent the cell diameter. The vitreous layer 215 is typically characterized by at least about 300 cells per cubic centimeter, although the cell density may be substantially more or less than 300 cells per cubic centimeter. The bulk density of the vitreous layer 215 is typically between about 0.1 and 0.35 grams per cubic centimeter, although in some embodiments the density of the vitreous layer may be substantially outside the 0.1 to 0.35 grams per cubic centimeter range. The vitreous layer 215 is typically substantially amorphous, having only trace amounts of crystalline character. More typically, the vitreous layer 215 is substantially completely amorphous. Also typically, the orientation of the cells is substantially completely random, i.e., the layer 215 is isotropic in character regarding its physical properties.

The impact layer 220 is typically formed of stacked layers a tough material, such as a fibrous materials (e.g., KEVLAR), organic aramids, polymers, ceramic plates, ceramic composites, cer-mets, meshes, metal-fiberglass meshes, woven fabrics, wires, metals, foamed metals, or the like. Typically, the impact layer 220 is selected such that the system 210 has a characteristic overall density of less than 0.6 grams per cubic centimeter.

The impact layer 220 further includes top and bottom laminated portions 240 consisting of a number of layers or sheets 241 characterized by fibers oriented along major axial directions rotated some predetermined amount, such as about 45 degrees, with respect to each other. For example, a laminated potion may include a first sheet of material 244 characterized by fibers oriented along a first major axis 245 (denoted here as 0 degrees), a second sheet of material 246 characterized by fibers oriented along a second major axis 247 rotated 45 degrees relative to the first major axis 245, and a third sheet of material 248 positioned between the first and second sheets 244, 246 and characterized by fibers oriented along a third major axis 249 rotated 45 degrees relative to the first major axis 245; the sheets 244, 246, 248 are all laminated together to define a laminated portion 240.

The pouch portion 242 is formed similarly to the laminated portions 240, with the exceptions of 1) typically (though not necessarily) having a greater number of sheets 241 included therein and 2) the sheets 241 are stacked but not laminated. In other words, the armor system 210 typically comprises at least one impact layer 220, and typically a plurality of impact layers 220, each including a first plurality 240 of adjacently stacked sheets 241, a second plurality 242 of adjacently stacked sheets 241 (the pouch), and a third plurality 240 of adjacently stacked sheets 241, wherein each respective sheet 244, 246 is characterized by elongated fibers generally aligned along a major axis 245, 247. Each sheet 241 is oriented such that its respective major axis is nonparallel with the respective major axes of any adjacently stacked sheet 241. The respective first and third pluralities 240 of adjacently stacked sheets 241 are laminated together and the second plurality 242 of adjacently stacked sheets 241 is disposed between the first and third pluralities 240 of adjacently stacked sheets 241.

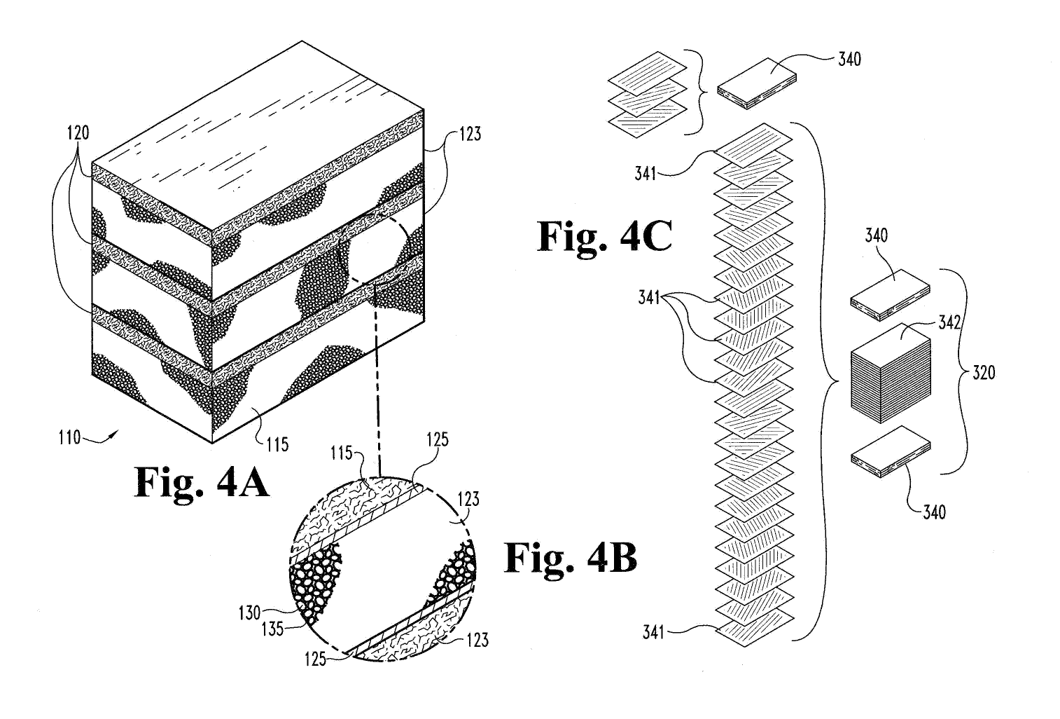

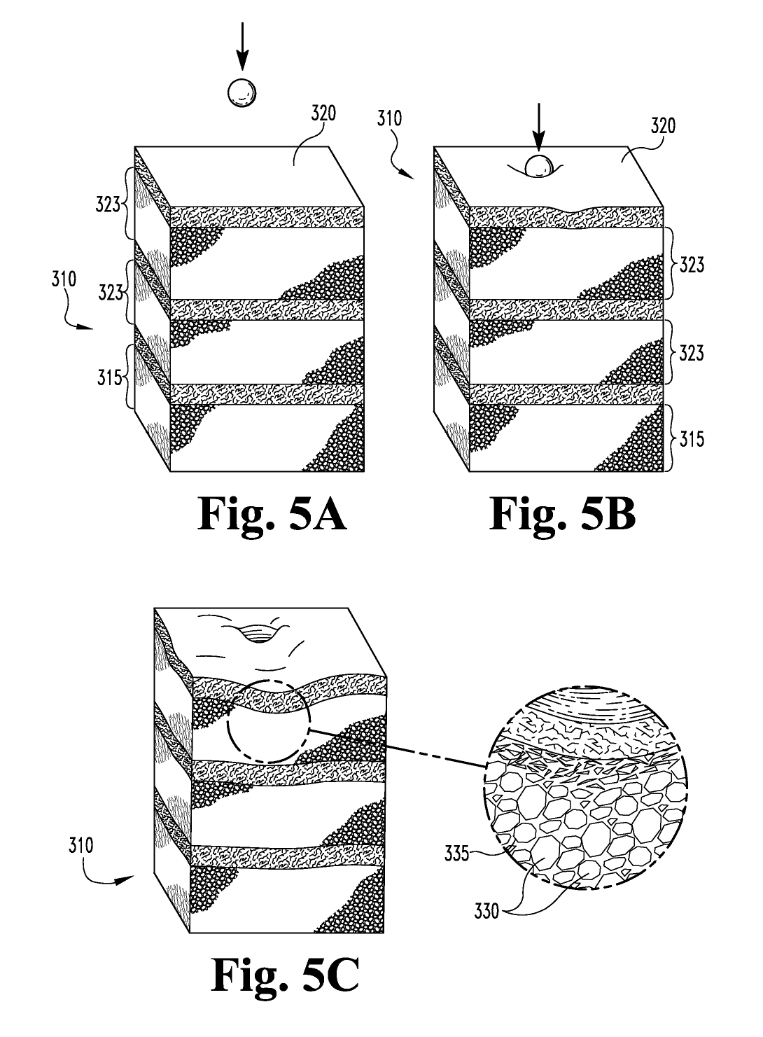

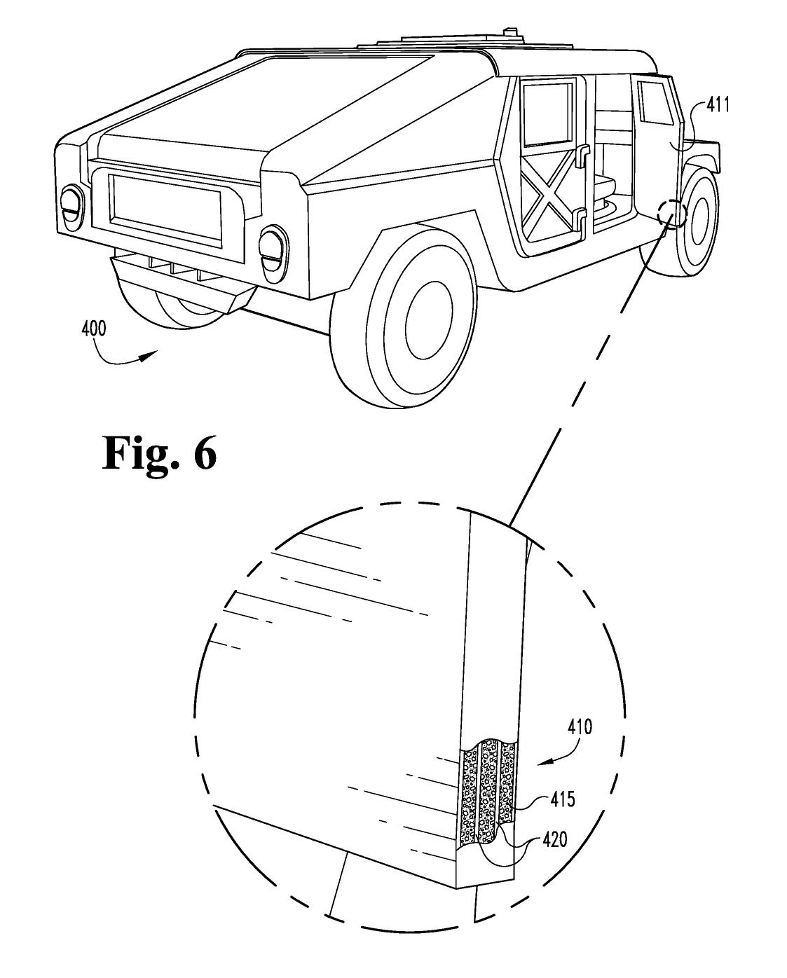

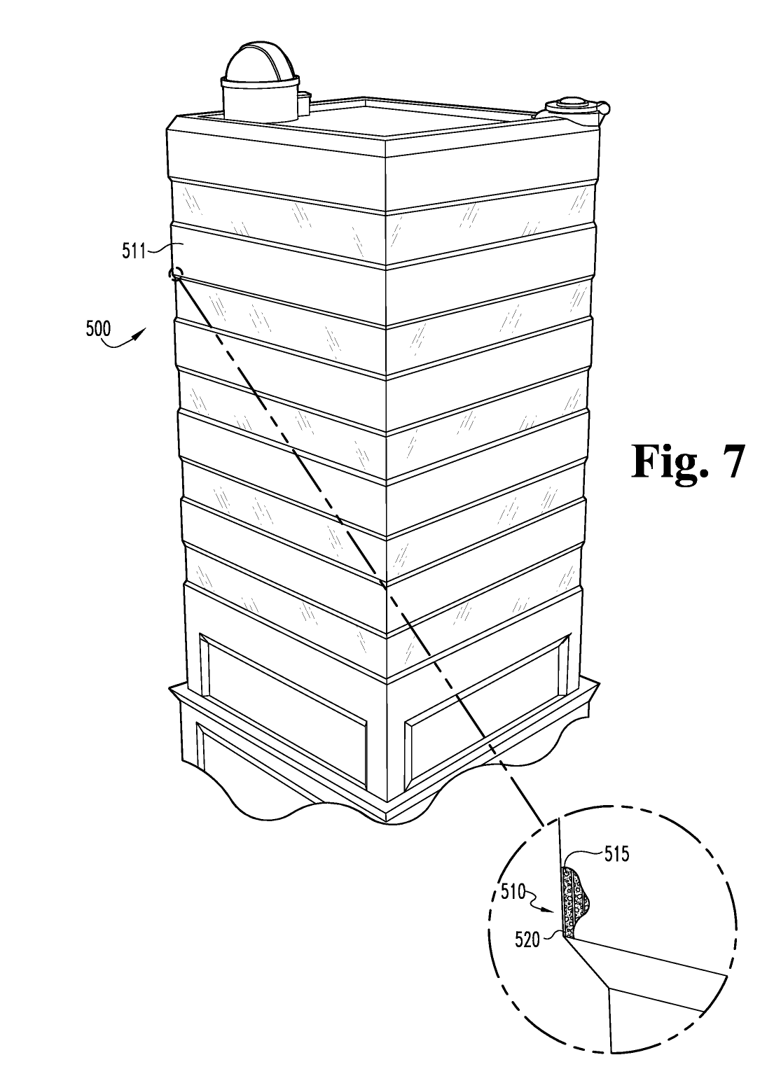

FIGS. 4A-4C illustrate a fourth embodiment of the novel technology, a substantially rigid laminate or layered armor system 310 similar to that illustrated as FIGS. 2A-2B and 3A-3C and described above, having an foamed vitreous base layer 315 adjacent an impact layer 320 similar to 220 described above, but wherein multiple impact layers 320, each further including top and bottom laminated portions 340 with multilayered pouch portions 342 positioned therebetween, are alternated with multiple base layers 315. The laminated portions 340 and pouch portions 342 are further characterized by pluralities of stacked sheets 341 of fibrous material, wherein the major axis of fiber orientation of each sheet 341 is oriented noncongruently with the major axis of adjacent the sheet(s) 341.

As with the previous embodiments, the embodiment illustrated in FIGS. 4A-4C includes a first or base layer 315 made of a foamed vitreous material and a plurality of impact layers 320 of a relatively tough material alternating with foamed vitreous layers 323. As in the previous embodiment, the foamed vitreous layers 315, 323 are bonded or adhered to the adjacent impact layers 320, such as by intermediate bonding layers 325 of cementitious, polymer-based, or like material. In other words, the armor system 310 typically comprises at least one impact layer 320, and typically a plurality of impact layers 320, each including a first plurality 340 of adjacently stacked sheets 341, a second plurality 342 of adjacently stacked sheets 341 (the pouch), and a third plurality 340 of adjacently stacked sheets 341, wherein each respective sheet 341 is characterized by elongated fibers generally aligned along a major axis. Each sheet is oriented such that its respective major axis is nonparallel with the respective major axes of any adjacently stacked sheet 341. The respective first and third pluralities 340 of adjacently stacked sheets 341 are laminated together and the second plurality 342 of adjacently stacked sheets 341 is disposed between the first and third pluralities 340 of adjacently stacked sheets 341.

As above, the vitreous layers 315, 323 are typically an isotropic foamed glass material with a substantially uniformly sized cell structure 330. The cells 330 typically range from between about 0.1 to 1 millimeter across and have walls 335 about 5 percent to about 50 percent the thickness of the cell 330. The impact layers 320 are likewise typically formed of a tough material like the layer 320 described above. Different respective impact layers 320 may have different compositions. Typically, the composition(s) of the impact layers 320 are selected such that the system 110 has a characteristic overall density of less than 0.6 grams per cubic centimeter.

In operation, the system(s) 210/310 operate to resist projectile penetration by spreading the energy of the projectile over a volume of armor 210/310, wherein the energy is directed to crushing hundreds of cells 230/330. As illustrated in FIGS. 5A-5C, a projectile impacting an outer impact layer 220/320 transfers most or all of its energy into the system 210/310 where it is expended breaking cell walls 235/335 in the base layer 215/315 and or intervening layers 323. The foamed vitreous layer(s) 215/315/323 thus mitigate transmission of the impact force of a projectile by redirecting the energy of the projectile for use in crushing pluralities of cells 230/330. In other words, the foamed vitreous material 215/315/323 acts to redirect the impact energy off the plane of attack, thus allowing the system 210/310 to both retard ballistic penetration and mitigate transmission of impact force. The cellular structure of the vitreous layer(s) 215/315/323 acts to broaden the compressive stress from a ballistic impact across a cross section of the rigid material 210/310 to redirect and absorb force though individual cell failure.

FIG. 6 illustrates another embodiment of the present novel technology, a vehicle having layered laminate armor positioned in its doors and/or side and/or top panels for absorbing the energy of impacting projectiles, thus stopping or substantially slowing the same. Typically, the laminate armor includes a plurality of layers of cellular foamed glass, each layer of foamed glass positioned between two impact layers. As above, the impact layers are typically adhered to the vitreous layers. The laminate armor thus provides lightweight protection against projectiles attempting to penetrate the vehicle doors and/or panels.

FIG. 7 illustrates still another embodiment of the novel technology, a building or structure having walls reinforced with laminate armor. The reinforced building typically defines a wall portion with a laminate armor portion operationally coupled thereto. As above, the laminate armor typically includes a plurality of layers of cellular foamed glass, each layer of foamed glass positioned between two impact layers, with the impact layers are typically adhered to the vitreous layers. While the armor is typically applied adjacent the exterior walls, laminate armor may just as readily be positioned to reinforce interior walls, doors, or the like. Such laminate armor provides lightweight and easily replaced protection against projectiles attempting to penetrate the building walls.

While the novel technology has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the novel technology are desired to be protected.

What is claimed is:

1. An impact resistant reinforced wall, comprising:
a wall portion; and
a laminate armor portion operationally coupled to the wall portion;
wherein the laminate armor portion further comprises:
a base layer of substantially foamed glass material; and
an outer layer of substantially relatively tough projectile retentive material;
wherein the foamed glass material is substantially isotropic;
wherein the foamed glass material has a bulk density of between about 0.1 and about 0.35 grams per cubic centimeter; and
wherein the foamed glass material is substantially amorphous.

2. The impact resistant reinforced wall of claim 1 wherein the wall portion is a building exterior wall.

3. The impact resistant reinforced wall of claim 1 wherein the wall portion is a vehicular panel.

4. The impact resistant reinforced wall of claim 1 wherein the wall portion is a door.

5. The impact resistant reinforced wall of claim 1 wherein the outer layer is substantially composed of organic aramid fibers.

6. The impact resistant reinforced wall of claim 1 wherein the outer layer is substantially composed of metal-fiberglass mesh.

7. The impact resistant reinforced wall of claim 1 further comprising a plurality of layers of foamed glass material and a plurality of layers of relatively tough projectile retentive material, wherein the layers of foamed glass material alternate with the layers of relatively tough projectile retentive material, wherein the outermost layer is relatively tough projectile retentive material and wherein the innermost layer is foamed glass.

8. The impact resistant reinforced wall of claim 7 wherein the plurality of layers of relatively tough projectile retentive material includes a first layer having a first composition and a second layer having a second, different composition.

9. The impact resistant reinforced wall of claim 1 wherein each layer of relatively tough projectile retentive material further comprises:
a first plurality of adjacently stacked sheets; and
a second plurality of adjacently stacked sheets;
wherein each respective sheet is characterized by elongated fibers generally aligned along a major axis;
wherein each sheet is oriented such that its respective major axis is nonparallel with the respective major axes of any adjacently stacked sheet.

10. An impact resistant vehicle, comprising:
a vehicle structural member;
an outer layer of relatively tough projectile retentive material;
a base layer of foamed glass material coupled to the outer layer of relatively tough projectile retentive material defining a laminate armor member;
wherein the laminate armor member is coupled to the vehicle structural member;
wherein the foamed glass material is substantially isotropic;
wherein the foamed glass material defines a plurality of interconnected cells; and
wherein the foamed glass material is substantially amorphous.

11. The impact resistant vehicle of claim 10 wherein the vehicle structural member is a door.

12. The impact resistant vehicle of claim 10 wherein the vehicle structural member is a side panel.

13. The impact resistant vehicle of claim 10 wherein the outer layer is substantially composed of organic aramid fibers.

14. The impact resistant vehicle of claim 10 wherein the outer layer is substantially composed of metal-fiberglass mesh.

15. The impact resistant vehicle of claim 10 further comprising a plurality of layers of foamed glass material and a plurality of layers of relatively tough projectile retentive material, wherein the layers of foamed glass material alternate with the layers of relatively tough projectile retentive material, wherein the outermost layer is relatively tough projectile retentive material and wherein the innermost layer is foamed glass.

16. The impact resistant vehicle of claim 15 wherein the plurality of layers of relatively tough projectile retentive material includes a first layer having a first composition and a second layer having a second, different composition.

17. The impact resistant vehicle of claim 15 wherein at least one impact layer further comprises further comprises a plurality of adjacently stacked sheets, wherein each respective sheet is characterized by elongated fibers generally aligned along a major axis and wherein each sheet is oriented such that its respective major axis is nonparallel with the respective major axes of any adjacently stacked sheet.

18. The impact resistant vehicle of claim 15 wherein at least one impact layer further comprises further comprises:
a first plurality of adjacently stacked sheets; and
a second plurality of adjacently stacked sheets;
wherein the first plurality of adjacently stacked sheets is laminated together;
wherein each respective sheet is characterized by elongated fibers generally aligned along a major axis; and
wherein each sheet is oriented such that its respective major axis is nonparallel with the respective major axes of any adjacently stacked sheet.

19. The impact resistant vehicle of claim 15 wherein at least one impact layer further comprises further comprises:
a first plurality of adjacently stacked sheets;
a second plurality of adjacently stacked sheets;
a third plurality of adjacently stacked sheets;
wherein each respective sheet is characterized by elongated fibers generally aligned along a major axis;
wherein each sheet is oriented such that its respective major axis is nonparallel with the respective major axes of any adjacently stacked sheet;
wherein the respective first and third pluralities of adjacently stacked sheets are laminated together; and
wherein the second plurality of adjacently stacked sheets is disposed between the first and third pluralities of adjacently stacked sheets.

20. An impact resistant structure, comprising:
a structural member;
an outer layer of relatively tough projectile retentive material;
a base layer of foamed glass material coupled to the outer layer of relatively tough projectile retentive material defining a laminate armor member;
wherein the laminate armor member is coupled to the structural member;
wherein the foamed glass material is substantially isotropic;
wherein the foamed glass material defines a plurality of interconnected cells; and
wherein the foamed glass material is substantially amorphous.

21. The impact resistant structure of claim 20 wherein the structural member is a building door.

22. The impact resistant structure of claim 20 wherein the structural member is an building exterior wall.

23. The impact resistant structure of claim 20 wherein the outer layer is substantially composed of organic aramid fibers.

24. The impact resistant structure of claim 20 wherein the outer layer is substantially composed of metal-fiberglass mesh.

25. The impact resistant structure of claim 20 further comprising a plurality of layers of foamed glass material and a plurality of layers of relatively tough projectile retentive material, wherein the layers of foamed glass material alternate with the layers of relatively tough projectile retentive material, wherein the outermost layer is relatively tough projectile retentive material and wherein the innermost layer is foamed glass.

26. The impact resistant structure of claim 25 wherein the plurality of layers of relatively tough projectile retentive material includes a first layer having a first composition and a second layer having a second, different composition.

27. The impact resistant structure of claim 25 wherein at least one impact layer further comprises further comprises a plurality of adjacently stacked sheets, wherein each respective sheet is characterized by elongated fibers generally aligned along a major axis and wherein each sheet is oriented such that its respective major axis is nonparallel with the respective major axes of any adjacently stacked sheet.

28. The impact resistant structure of claim 25 wherein at least one impact layer further comprises further comprises:
a first plurality of adjacently stacked sheets; and
a second plurality of adjacently stacked sheets;
wherein the first plurality of adjacently stacked sheets is laminated together;
wherein each respective sheet is characterized by elongated fibers generally aligned along a major axis; and
wherein each sheet is oriented such that its respective major axis is nonparallel with the respective major axes of any adjacently stacked sheet.

29. The impact structure vehicle of claim 25 wherein at least one impact layer further comprises further comprises:
a first plurality of adjacently stacked sheets;
a second plurality of adjacently stacked sheets;
a third plurality of adjacently stacked sheets;
wherein each respective sheet is characterized by elongated fibers generally aligned along a major axis;
wherein each sheet is oriented such that its respective major axis is nonparallel with the respective major axes of any adjacently stacked sheet;
wherein the respective first and third pluralities of adjacently stacked sheets are laminated together; and
wherein the second plurality of adjacently stacked sheets is disposed between the first and third pluralities of adjacently stacked sheets.
